(19) United States
(12) Patent Application Publication
(10) Pub. No.: US 2025/0314181 A1
(43) Pub. Date: Oct. 9, 2025

(54) DETERIORATION DETERMINATION DEVICE, DETERIORATION DETERMINATION SYSTEM, AND DETERIORATION DETERMINATION METHOD

(71) Applicant: MITSUBISHI HEAVY INDUSTRIES, LTD., Tokyo (JP)

(72) Inventors: Takuya TAKEDA, Tokyo (JP); Satoshi Hada, Tokyo (JP); Shinya Hashimoto, Tokyo (JP); Susumu Wakazono, Tokyo (JP); Kenji Nanataki, Tokyo (JP); Eiichi Kobayashi, Tokyo (JP)

(21) Appl. No.: 19/092,390

(22) Filed: Mar. 27, 2025

(30) Foreign Application Priority Data
Apr. 4, 2024 (JP) 2024-060563

(51) Int. Cl. F01D 21/00; G01M 13/005

(52) U.S. Cl. CPC F01D 21/003; G01M 13/005; F05D 2240/56; F05D 2260/80

(57) ABSTRACT

A deterioration determination device determines whether a sealing device of a rotating machine has deteriorated. The rotating machine includes: a rotor; a bearing rotatably supporting the rotor; a bearing box surrounding the bearing; a sealing air supply pipe; and a casing surrounding the bearing box. The casing separates the bearing box from an external space filled with high-temperature, high-pressure gas that has a higher temperature and higher pressure than the sealing air. The casing includes an inner peripheral surface on which the sealing device is arranged between the inner peripheral surface and an outer peripheral surface of the rotor. The deterioration determination device is configured to determine that the sealing device has deteriorated when a first pressure corresponding to pressure of a first space formed between the casing and the bearing box is greater than a second pressure corresponding to pressure of a second space formed inside the bearing box.

### TECHNICAL FIELD

The present disclosure relates to a deterioration determination device, a deterioration determination system, and a deterioration determination method for determining whether a sealing device of a rotating machine such as a gas turbine has deteriorated.

The present application claims priority based on Japanese Patent Application No. 2024-060563 filed on Apr. 4, 2024, the entire content of which is incorporated herein by reference.

### BACKGROUND ART

Rotating machines such as gas turbines are equipped with sealing devices. For example, the gas turbine disclosed in Patent Document 1 includes a rotor, a bearing rotatably supporting the rotor, a bearing box containing the bearing, a casing containing the bearing box, and an outer seal ring disposed between the casing and the rotor.

### CITATION LIST

### Patent Literature

Patent Document 1: JPS61-108808A

### SUMMARY

The outer seal ring may deteriorate over time. However, the above document does not disclose a specific configuration for determining whether the outer seal ring has deteriorated.

An object of the present disclosure is to provide a deterioration determination device, a deterioration determination system, and a deterioration determination method that can accurately determine whether a sealing device of a rotating machine has deteriorated.

A deterioration determination device according to at least one embodiment of the present disclosure is a deterioration determination device for determining whether a sealing device of a rotating machine has deteriorated. The rotating machine includes: a rotor; a bearing rotatably supporting the rotor; a bearing box surrounding the bearing; a sealing air supply pipe that defines a sealing air supply passage for sealing air supplied to the bearing box to flow; and a casing surrounding the bearing box, the casing separating the bearing box from an external space filled with high-temperature, high-pressure gas that has a higher temperature and higher pressure than the sealing air, the casing including an inner peripheral surface on which the sealing device is arranged between the inner peripheral surface and an outer peripheral surface of the rotor. The deterioration determination device includes a determination part configured to determine that the sealing device has deteriorated when a first pressure corresponding to pressure of a first space formed between the casing and the bearing box is greater than a second pressure corresponding to pressure of a second space formed inside the bearing box.

A deterioration determination system according to an embodiment of the present disclosure includes the deterioration determination device and the rotating machine.

A deterioration determination method according to an embodiment of the present disclosure is a deterioration determination method for determining whether a sealing device of a rotating machine has deteriorated. The rotating machine includes: a rotor; a bearing rotatably supporting the rotor; a bearing box surrounding the bearing; a sealing air supply pipe that defines a sealing air supply passage for sealing air supplied to the bearing box to flow; and a casing surrounding the bearing box, the casing separating the bearing box from an external space filled with high-temperature, high-pressure gas that has a higher temperature and higher pressure than the sealing air, the casing including an inner peripheral surface on which the sealing device is arranged between the inner peripheral surface and an outer peripheral surface of the rotor. The deterioration determination method includes a determination step of determining that the sealing device has deteriorated when a first pressure corresponding to pressure of a first space formed between the casing and the bearing box is greater than a second pressure corresponding to pressure of a second space formed inside the bearing box.

The present disclosure provides a deterioration determination device, a deterioration determination system, and a deterioration determination method that can accurately determine whether a sealing device of a rotating machine has deteriorated.

### BRIEF DESCRIPTION OF DRAWINGS

FIG. 1 is a schematic diagram of a deterioration determination system according to an embodiment.

FIG. 2 is a schematic diagram of a gas generator part according to an embodiment.

FIG. 3 is an enlarged view of a bearing according to an embodiment.

FIG. 4 is a flowchart of a deterioration determination method according to an embodiment.

### DETAILED DESCRIPTION

Embodiments of the present disclosure will be described below with reference to the accompanying drawings. It is intended, however, that unless particularly identified, dimensions, materials, shapes, relative positions, and the like of components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

The same configurations are indicated by the same reference signs and may not be described again in detail.

### Deterioration Determination System 100

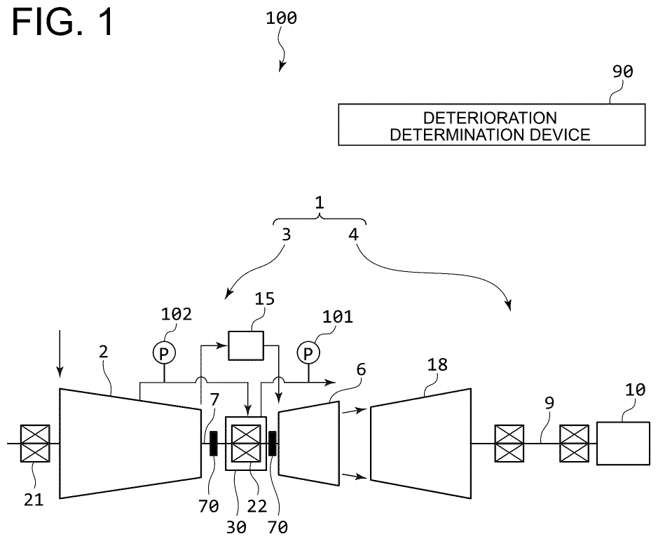

FIG. 1 is a schematic diagram of a deterioration determination system 100 according to an embodiment of the present disclosure. The deterioration determination system 100 is equipped with a gas turbine 1 as an example of a rotating machine, and a deterioration determination device 90 for determining whether a sealing device 70 installed in the gas turbine 1 has deteriorated. The number of sealing devices 70 can be single or multiple, and in this example, two sealing devices 70 are installed. The deterioration determination device 90 is realized by a computer equipped with a processor.

In the following description, the axial direction, circumferential direction, and radial direction of the gas turbine 1 may be referred to simply as the “axial direction”, “circumferential direction”, and “radial direction”, respectively. The axial direction is the horizontal direction.

### Gas Turbine 1

The gas turbine 1 illustrated in FIG. 1 is a two-axis gas turbine in which a high-pressure turbine 6 and a low-pressure turbine 18 rotate independently of each other. More specifically, the gas turbine 1 in this example includes a gas generator part 3 which incorporates the high-pressure turbine 6, and a power generation part 4 which incorporates the low-pressure turbine 18. As will be described in detail below, the sealing device 70 is installed in the gas generator part 3.

The gas generator part 3 includes a compressor 2, a combustor 15 for burning a mixed gas of compressed air discharged from the compressor 2 and fuel gas added, a high-pressure turbine 6 rotationally driven by combustion gas discharged from the combustor 15 as a working medium, and a first rotor 7 connected to the compressor 2 and the high-pressure turbine 6. The rotational drive force of the high-pressure turbine 6 is transmitted to the compressor 2 via the first rotor 7, so that the compressor 2 is rotationally driven.

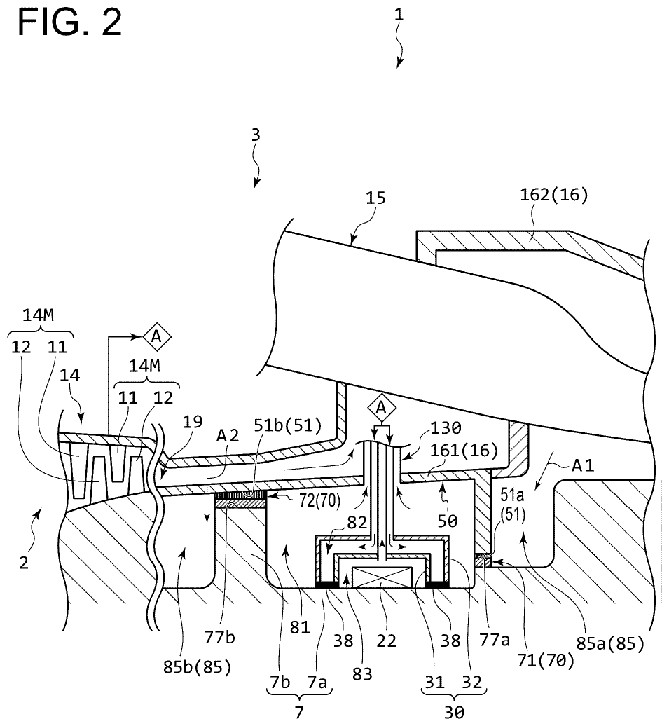

As shown in FIG. 2, the compressor 2 includes multiple stages 14. Each stage 14 is composed of a plurality of circumferentially arranged stator vanes 11 and a plurality of circumferentially arranged rotor blades 12 directly downstream of the plurality of stator vanes 11. The multiple stages 14 are arranged between the compressor inlet and the compressor outlet 19. The multiple stages 14 include multiple intermediate stages 14M between the first and last stages. In this example, compressed air that has passed through any one of the multiple intermediate stages 14M is extracted and supplied to the bearing box 30.

Returning to FIG. 1, the power generation part 4 includes a low-pressure turbine 18 rotated by combustion gas that has passed through the high-pressure turbine 6 as a working medium, a generator 10 for generating electric power, and a second rotor 9 connected to the low-pressure turbine 18 and the generator 10. The rotational drive force of the low-pressure turbine 18 is transmitted to the generator 10 via the second rotor 9, so that the generator 10 generates electric power. In the gas turbine 1 illustrated in FIG. 1, the high-pressure turbine 6 and the low-pressure turbine 18 can rotate independently of each other, allowing the output of the high-pressure turbine 6 to be maintained while controlling the output of the low-pressure turbine 18 when the power load of the generator 10 changes.

The gas generator part 3 further includes a first bearing 21 and a second bearing 22 each rotatably supporting the first rotor 7. The first bearing 21 is located on the opposite side of the compressor 2 from the high-pressure turbine 6 in the axial direction, and the second bearing 22 is located between the compressor 2 and the high-pressure turbine 6 in the axial direction. For convenience of explanation, the second bearing 22 may be referred to as “bearing 22” in the following

### Surrounding Configuration of Bearing 22

As illustrated in FIG. 2, the gas generator part 3 further includes a bearing box 30 surrounding the bearing 22, a labyrinth seal 38 disposed between the bearing box 30 and the first rotor 7, and a casing 50 surrounding the bearing box 30.

The bearing box 30 includes an inner bearing box 31 surrounding the bearing 22, and an outer bearing box 32 surrounding the inner bearing box 31. The labyrinth seal 38 is disposed between the inner bearing box 31 and the first rotor 7 and between the outer bearing box 32 and the first rotor 7. The inner bearing box 31 is connected to an oil supply pipe (not shown), so that the lubricating oil from the oil supply pipe is supplied to a bearing placement space 83 in the inner bearing box 31.

The casing 50 in this example constitutes a part of a combustor casing 16 that supports the combustor 15. More specifically, the combustor casing 16 includes an inner-diameter side wall part 161 and an outer-diameter side wall part 162 that define the compressed air passage from the compressor 2 to the combustor 15, and the casing 50 constitutes a part of the inner-diameter side wall part 161.

The casing 50 separates the bearing box 30 from an external space 85 of the casing 50. As a more specific example, the casing 50 cooperates with a protruding wall portion 7b protruding radially from a body portion 7a of the first rotor 7 to separate the bearing box 30 from the external space 85. The external space 85 in this example includes a first external space 85a and a second external space 85b that are arranged in the axial direction with the casing 50 and the protruding wall portion 7b therebetween. The first external space 85a and the second external space 85b are filled with high-temperature, high-pressure compressed air discharged from the compressor outlet 19 (Arrows A1, A2).

The casing 50 includes an inner peripheral surface 51. The inner peripheral surface 51 has a first inner peripheral surface 51a located on the high-pressure turbine 6 side relative to the bearing box 30 in the axial direction, and a second inner peripheral surface 51b located on the compressor 2 side relative to the bearing box 30 in the axial direction. The first inner peripheral surface 51a faces an outer peripheral surface 77a of the body portion 7a of the first rotor 7, and the second inner peripheral surface 51b faces an outer peripheral surface 77b of the protruding wall portion 7b of the first rotor 7. The second inner peripheral surface 51b is located radially outward of the first inner peripheral surface 51a.

The sealing device 70 includes a first sealing device 71 disposed between the first inner peripheral surface 51a and the outer peripheral surface 77a, and a second sealing device 72 disposed between the second inner peripheral surface 51b and the outer peripheral surface 77b. Both the first sealing device 71 and the second sealing device 72 are brush seals. The sealing effect of each of the first sealing device 71 and the second sealing device 72 prevents compressed air filling the external space 85 from flowing into a first space 81 formed between the casing 50 and the outer bearing box 32. As will be described in detail below, sealing air flows into the first space 81 from a second space 82 formed between the outer bearing box 32 and the inner bearing box 31.

### Piping Part 130

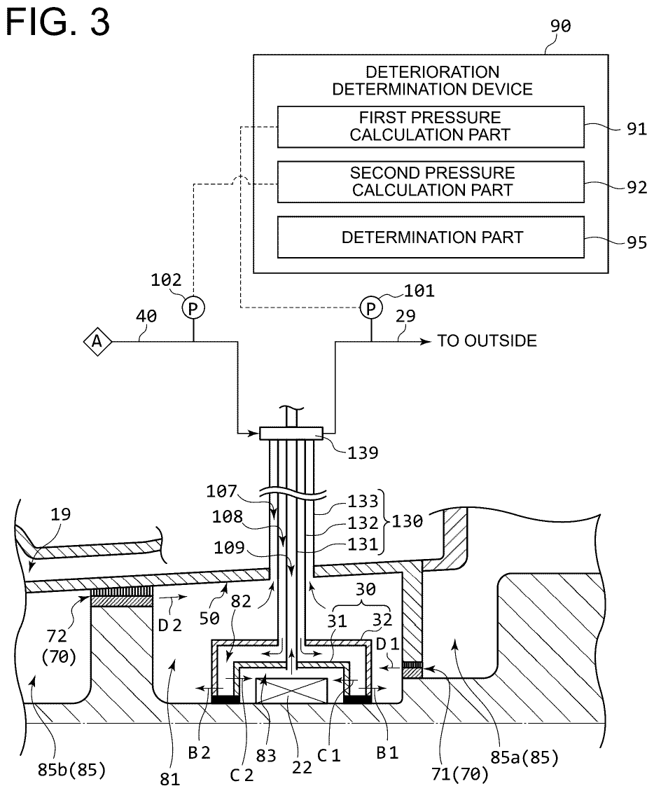

As shown in FIG. 3, the gas turbine 1 further includes a piping part 130 with a triple-tube structure. The piping part 130 includes a first tubular part 131 extending upward from the inner bearing box 31, a second tubular part 132 surrounding the first tubular part 131 and extending upward from the outer bearing box 32, and a third tubular part 133 surrounding the second tubular part 132 and extending upward from the casing 50.

The first tubular part 131 is connected to a through hole provided in the inner bearing box 31. The inner peripheral surface of the first tubular part 131 defines an oil discharge passage 109 for leading oil mist in the bearing placement space 83 to an oil tank (not shown). The first tubular part 131 is connected to the oil tank, and the pressure in the interior space of the oil tank is lower than atmospheric pressure. Therefore, oil mist in the bearing placement space 83 can flow to the oil tank through the oil discharge passage 109.

The second tubular part 132 is connected to a through hole provided in the outer bearing box 32. The inner peripheral surface of the second tubular part 132 and the outer peripheral surface of the first tubular part 131 define at least a part of the sealing air supply passage 108. The sealing air supply passage 108 is a flow passage for the compressed air extracted from the intermediate stage 14M (see FIG. 2) to flow as sealing air to the second space 82. In this example, the downstream portion of the sealing air supply passage 108 is defined by the first tubular part 131 and the second tubular part 132, and the upstream portion of the sealing air supply passage 108 is defined by a sealing air supply pipe 40. The sealing air supply pipe 40 is connected to a compressor casing of the compressor 2 and a branch portion 139 disposed at the upper end of the piping part 130. The sealing air flowing into the second space 82 through the sealing air supply passage 108 passes between the outer bearing box 32 and the labyrinth seal 38 and flows into the first space 81 (Arrows B1, B2).

The third tubular part 133 is connected to a through hole provided in the casing 50. The inner peripheral surface of the third tubular part 133 and the outer peripheral surface of the second tubular part 132 define at least a part of the sealing air discharge passage 107. The sealing air discharge passage 107 is a flow passage for the sealing air that flows from the second space 82 to the first space 81 to be discharged outside the gas turbine 1. In this example, the upstream portion of the sealing air discharge passage 107 is defined by the second tubular part 132 and the third tubular part 133, and the downstream portion is defined by the discharge pipe 29. The discharge pipe 29 extends from the branch portion 139 of the piping part 130 to the outside of the gas turbine 1.

Some of the sealing air filling the first space 81 may pass between the inner bearing box 31 and the labyrinth seal 38 and flow into the bearing placement space 83 (Arrows C1, C2). The sealing air in the bearing placement space 83 is discharged to the outside of the gas turbine 1 through the oil discharge passage 109.

### Deterioration Determination Device 90

According to the inventor's knowledge, when the sealing device 70 deteriorates, compressed air in the external space 85 passes through the sealing device 70 into the first space 81 (Arrows D1, D2). The compressed air in the external space 85 is compressed air discharged from the compressor outlet 19 and has a higher temperature and higher pressure than the compressed air (sealing air) extracted from the intermediate stage 14M and flowing through the first space 81. Therefore, the compressed air flowing into the first space 81 from the external space 85 flows into the second space 82 via the labyrinth seal 38. As a result of the increased temperature inside the bearing box 30, the lubricating oil in the bearing placement space 83 may deteriorate, causing the bearing 22 to fail.

Therefore, in the present embodiment, the deterioration determination device 90 is provided to determine whether the sealing device 70 has deteriorated. The deterioration determination device 90 includes a first pressure calculation part 91, a second pressure calculation part 92, and a determination part 95.

The first pressure calculation part 91 calculates the first pressure corresponding to the pressure of the first space 81 based on the measurement results of a first pressure gauge 101 for measuring the pressure in the discharge pipe 29. The second pressure calculation part 92 calculates the second pressure corresponding to the pressure of the second space 82 based on the measurement results of a second pressure gauge 102 for measuring the pressure in the sealing air supply pipe 40. The determination part 95 determines that the sealing device 70 has deteriorated when the first pressure calculated by the first pressure calculation part 91 is greater than the second pressure calculated by the second pressure calculation part 92.

When the sealing device 70 has not deteriorated, the second pressure is slightly

higher than the first pressure. However, as the sealing device 70 deteriorates, the first pressure increases because high-temperature, high-pressure compressed air flows into the first space 81 from the external space 85. As a result, the first pressure becomes greater than the second pressure. With the above configuration, the determination part 95 can determine that the sealing device 70 has deteriorated in this case. Thus, it is possible to achieve the deterioration determination device 90 that can accurately determine whether the sealing device 70 has deteriorated, and it is possible to avoid the bearing 22 of the gas turbine 1 from failing.

Each of the first pressure gauge 101 and the second pressure gauge 102 may be arranged in the piping part 130. Even in this case, the first and second pressures can be identified. Alternatively, the determination part 95 may determine a greater or lesser relationship between the first and second pressures based on parameters correlated with the first and second pressures. Even in this case, the above-described technical advantages are obtained.

With the configuration in which the first pressure gauge 101 and the second pressure gauge 102 are provided in the discharge pipe 29 and the sealing air supply pipe 40, respectively, the determination part 95 can determine whether the sealing device 70 has deteriorated based on measured values of the first pressure gauge 101 and the second pressure gauge 102. Additionally, since the first pressure gauge 101 and the second pressure gauge 102 can be arranged outside the casing 50, the pressure can be measured more easily than if these pressure gauges are arranged inside the casing 50. Additionally, since the first pressure gauge 101 and the second pressure gauge 102 in this example are arranged outside the combustor casing 16, pressure measurement is further facilitated.

In some embodiments, the first pressure calculation part 91 may calculate the first pressure by adding a first correction value to the measured value of the first pressure gauge 101. The first correction value is equivalent to the first pressure loss in the sealing air discharge passage 107 from the casing 50 to the first pressure gauge 101. The first pressure loss can be determined in advance by calculation or actual measurement. Further, the first correction value may be the sum of the first pressure loss and a margin value which is a specified percentage of the first pressure loss.

The second pressure calculation part 92 may calculate the second pressure by subtracting a second correction value from the measured value of the second pressure gauge 102. The second correction value is equivalent to the second pressure loss in the sealing air supply passage 108 from the second pressure gauge 102 to the outer bearing box 32. The second pressure loss is a value determined in advance by calculation or actual measurement. The second correction value may be the same value as the second pressure loss.

With the above configuration, the first pressure loss in the sealing air discharge passage 107 and the second pressure loss in the sealing air supply passage 108 are taken into account in calculating the first and second pressures. This reduces the difference between the first pressure calculated by the first pressure calculation part 91 and the actual pressure in the first space 81 and similarly reduces the difference between the second pressure calculated by the second pressure calculation part 92 and the actual pressure in the second space 82. Therefore, the determination part 95 can more accurately determine whether the sealing device 70 has deteriorated.

Additionally, in the above embodiment, the sealing air supply pipe 40 supplies sealing air to the second space 82 formed between the inner bearing box 31 and the outer bearing box 32. With this configuration, even when high-temperature, high-pressure compressed air flows into the first space 81 from the external space 85, the compressed air is prevented from entering the bearing placement space 83 of the inner bearing box 31. This reduces the possibility of the bearing 22 failing.

Additionally, in the above embodiment, the sealing device 70 is a brush seal. In the gas turbine 1, the pressure difference between the external space 85, which is filled with the high-temperature, high-pressure compressed air discharged from the compressor outlet 19, and the first space 81, through which the sealing air flows, is large, so a brush seal with high sealing properties should be employed as the sealing device 70. However, the brush seal is likely to deteriorate over time due to sliding between the brush seal and the casing 50 during rotation of the first rotor 7. In this regard, with the above configuration, the determination part 95 can accurately determine the deterioration of the brush seal, properly monitoring the aging of the brush seal.

### Deterioration Determination Method

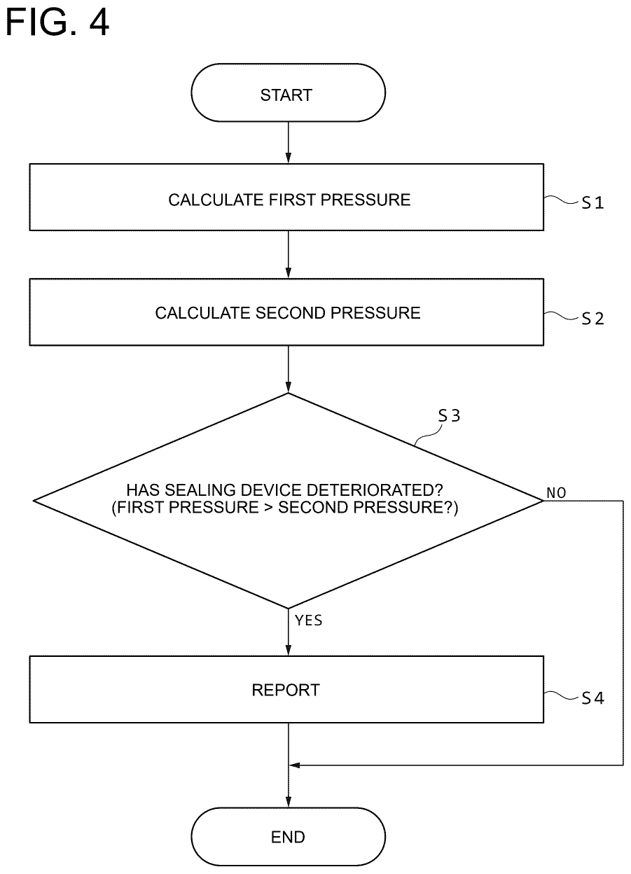

FIG. 4 is a flowchart showing a deterioration determination method for the sealing device 70. The deterioration determination method is executed by a processor of the sealing device 70. In the following, step may be abbreviated as “S”.

First, the processor calculates the first pressure (S1). Specifically, the processor calculates the first pressure by adding the first correction value to the measured value of the first pressure gauge 101. The processor executing S1 is an example of the first pressure calculation part 91.

Then, the processor calculates the second pressure (S2). Specifically, the processor calculates the second pressure by subtracting the second correction value from the measured value of the second pressure gauge 102. The processor executing S2 is an example of the second pressure calculation part 92.

Then, the processor determines whether the sealing device 70 has deteriorated (S3). Specifically, the processor determines whether the first pressure calculated in S1 is greater than the second pressure calculated in S2. If the first pressure is less than or equal to the second pressure (S3: NO), the processor determines that the sealing device 70 has not deteriorated and ends this flowchart. Conversely, if the first pressure is greater than the second pressure (S3: YES), the processor reports that the sealing device 70 has deteriorated (S4). For example, the processor may display a message on a personal computer monitor indicating the deterioration of the sealing device 70. The processor ends the flowchart after executing S4. The processor executing S3 is an example of the determination part 95.

### Modification

The present disclosure is not limited to the casing 50 cooperating with the protruding wall portion 7b to separate the bearing box 30 from the external space 85. In other words, the protruding wall portion 7b of the first rotor 7 is not an essential component of this disclosure. The casing 50 may have a radial extension part that extends in the radial direction in the space where the protruding wall portion 7b would be disposed. In this case, the casing 50 separates the bearing box 30 from the external space 85 alone.

The gas turbine 1 does not have to include the piping part 130. In this case, the sealing air supply pipe 40 may be connected to the outer bearing box 32 and the discharge pipe 29 to the casing 50. In other words, the sealing air supply passage 108 may be defined only by the sealing air supply pipe 40, and the sealing air discharge passage 107 may be defined only by the sealing air supply pipe 40. The gas turbine 1 may be a single-axis gas turbine instead of a two-axis gas turbine. Further, the rotating machine may be the compressor 2 instead of the gas turbine 1.

The flowchart shown in FIG. 4 may be executed by an operator instead of the processor. In other words, the calculation of the first pressure (S1), the calculation of the second pressure (S2), and the determination of the greater or lesser relationship between the first and second pressures (S3) may all be performed by the operator.

### Others

The deterioration determination device 90 is configured by a computer, and includes a processor, a memory (storage medium), and an external communication interface. The processor is, for example, CPU, GPU, MPU, DSP, or a combination of these. A processor according to another embodiment may be implemented by an integrated circuit such as PLD,

ASIC, FPGA, MCU, or the like. The memory is configured to temporarily or non-temporarily store various data, and is implemented by at least one of RAM, ROM, or flash memory. The processor executes various control processes in accordance with programs loaded in the memory.

### Conclusion

The contents described in some embodiments described above would be understood as follows, for instance.
1) A deterioration determination device (90) according to at least one embodiment of the present disclosure is a deterioration determination device (90) for determining whether a sealing device (70) of a rotating machine (gas turbine 1) has deteriorated. The rotating machine includes: a rotor (first rotor 7); a bearing (22) rotatably supporting the rotor; a bearing box (30) surrounding the bearing; a sealing air supply pipe (40) that defines a sealing air supply passage (108) for sealing air supplied to the bearing box to flow; and a casing (50) surrounding the bearing box, the casing separating the bearing box from an external space (85) filled with high-temperature, high-pressure gas that has a higher temperature and higher pressure than the sealing air, the casing including an inner peripheral surface (51) on which the sealing device is arranged between the inner peripheral surface and an outer peripheral surface (77a, 77b) of the rotor. The deterioration determination device includes a determination part (95) configured to determine that the sealing device has deteriorated when a first pressure corresponding to pressure of a first space (81) formed between the casing and the bearing box is greater than a second pressure corresponding to pressure of a second space (82) formed inside the bearing box.

When the sealing device deteriorates, high-temperature, high-pressure gas in the external space flows through the sealing device into the first space, causing the first pressure to increase. In this regard, with the above configuration 1), the determination part determines that the sealing device has deteriorated when the first pressure is greater than the second pressure. Thus, it is possible to achieve the deterioration determination device that can accurately determine whether the sealing device has deteriorated.
2) In some embodiments, in the deterioration determination device described in 1), the rotating machine includes: a discharge pipe (29) that defines a sealing air discharge passage (107) for the sealing air that flows from the bearing box into the first space to flow outside the rotating machine; a first pressure gauge (101) for measuring pressure inside the discharge pipe; and a second pressure gauge (102) for measuring pressure inside the sealing air supply pipe.

The deterioration determination device further includes: a first pressure calculation part (91) for calculating the first pressure based on a measured value of the first pressure gauge; and a second pressure calculation part (92) for calculating the second pressure based on a measured value of the second pressure gauge.

With the configuration 2), the determination part can determine whether the sealing device has deteriorated based on measured values of the first pressure gauge and the second pressure gauge. Since the first pressure gauge and the second pressure gauge can be arranged outside the casing, the pressure can be measured more easily than if these pressure gauges are arranged inside the casing.
3) In some embodiments, in the deterioration determination device described in 2), the first pressure calculation part is configured to calculate the first pressure by adding a first correction value corresponding to a first pressure loss in the sealing air discharge passage from the casing to the first pressure gauge to the measured value of the first pressure gauge. The second pressure calculation part is configured to calculate the second pressure by subtracting a second correction value corresponding to a second pressure loss in the sealing air supply passage from the second pressure gauge to the bearing box from the measured value of the second pressure gauge.

With the above configuration 3), the first pressure loss in the sealing air discharge passage and the second pressure loss in the sealing air supply passage are taken into account in calculating the first and second pressures. This reduces the difference between the first pressure calculated by the first pressure calculation part and the actual pressure in the first space and similarly reduces the difference between the second pressure calculated by the second pressure calculation part and the actual pressure in the second space. Therefore, the determination part can more accurately determine whether the sealing device has deteriorated.
4) A deterioration determination system (100) according to at least one embodiment of the present disclosure includes: the deterioration determination device (90) described in any one of 1) to 3); and the rotating machine (gas turbine 1).

With the above configuration 4), the same technical advantages as in the above 1) are achieved.
5) In some embodiments, in the deterioration determination system described in 4), the bearing box has: an inner bearing box (31) surrounding the bearing; and an outer bearing box (32) surrounding the inner bearing box. The second space is a space between the inner bearing box and the outer bearing box. The sealing air supply pipe is configured to supply the sealing air into the second space.

With this configuration 5), since the sealing air is supplied to the second space formed between the inner bearing box and the outer bearing box, even when high-temperature, high-pressure gas flows into the first space from the external space, the high-temperature, high-pressure gas is prevented from entering the inner bearing box. This reduces the possibility of the bearing failing.
6) In some embodiments, in the deterioration determination system described in 5), the rotating machine is a gas turbine (1). The high-temperature, high-pressure gas is compressed air discharged from an outlet (compressor outlet 19) of a compressor (2) of the gas turbine. The sealing air is compressed air extracted from an intermediate stage (14M) of the compressor upstream of the outlet.

If high-temperature, high-pressure compressed air discharged from the compressor outlet enters the inner bearing box from the first space due to the deterioration of the sealing device, the lubricating oil in the inner bearing box may deteriorate. In this case, the bearing may fail. In this regard, with the above configuration 6), the deterioration determination device accurately determines the deterioration of the sealing device, so it is possible to avoid the bearing of the gas turbine from failing.
7) In some embodiments, in the deterioration determination system described in 6), the sealing device is a brush seal.

Since the pressure difference between the external space, which is filled with the high-temperature, high-pressure compressed air discharged from the compressor outlet, and the first space, through which the extracted compressed air flows as the sealing air, is large, a brush seal with high sealing properties should be employed as the sealing device. However, the brush seal is likely to deteriorate over time due to sliding between the brush seal and the casing during rotation of the rotor. In this regard, with the above configuration 7), the determination part can accurately determine the deterioration of the brush seal, properly monitoring the aging of the brush seal.
8) A deterioration determination method according to at least one embodiment of the present disclosure is a deterioration determination method for determining whether a sealing device (70) of a rotating machine (gas turbine 1) has deteriorated. The rotating machine includes: a rotor (first rotor 7); a bearing (22) rotatably supporting the rotor; a bearing box (30) surrounding the bearing; a sealing air supply pipe (40) that defines a sealing air supply passage (108) for sealing air supplied to the bearing box to flow; and a casing (50) surrounding the bearing box, the casing separating the bearing box from an external space (85) filled with high-temperature, high-pressure gas that has a higher temperature and higher pressure than the sealing air, the casing including an inner peripheral surface (51) on which the sealing device is arranged between the inner peripheral surface and an outer peripheral surface (77a, 77b) of the rotor. The deterioration determination method includes a determination step (S3) of determining that the sealing device has deteriorated when a first pressure corresponding to pressure of a first space (81) formed between the casing and the bearing box is greater than a second pressure corresponding to pressure of a second space (82) formed inside the bearing box.

With the above configuration 8), the same technical advantages as in the above 1) are achieved.

1. A deterioration determination device for determining whether a sealing device of a rotating machine has deteriorated,
the rotating machine including:
a rotor;
a bearing rotatably supporting the rotor;
a bearing box surrounding the bearing;
a sealing air supply pipe that defines a sealing air supply passage for sealing air supplied to the bearing box to flow; and
a casing surrounding the bearing box, the casing separating the bearing box from an external space filled with high-temperature, high-pressure gas that has a higher temperature and higher pressure than the sealing air, the casing including an inner peripheral surface on which the sealing device is arranged between the inner peripheral surface and an outer peripheral surface of the rotor,
the deterioration determination device comprising a determination part configured to determine that the sealing device has deteriorated when a first pressure corresponding to pressure of a first space formed between the casing and the bearing box is greater than a second pressure corresponding to pressure of a second space formed inside the bearing box.

2. The deterioration determination device according to claim 1,
wherein the rotating machine includes:
a discharge pipe that defines a sealing air discharge passage for the sealing air that flows from the bearing box into the first space to flow outside the rotating machine;
a first pressure gauge for measuring pressure inside the discharge pipe; and
a second pressure gauge for measuring pressure inside the sealing air supply pipe, and
wherein the deterioration determination device further comprises:
a first pressure calculation part for calculating the first pressure based on a measured value of the first pressure gauge; and
a second pressure calculation part for calculating the second pressure based on a measured value of the second pressure gauge.

3. The deterioration determination device according to claim 2,
wherein the first pressure calculation part is configured to calculate the first pressure by adding a first correction value corresponding to a first pressure loss in the sealing air discharge passage from the casing to the first pressure gauge to the measured value of the first pressure gauge, and
wherein the second pressure calculation part is configured to calculate the second pressure by subtracting a second correction value corresponding to a second pressure loss in the sealing air supply passage from the second pressure gauge to the bearing box from the measured value of the second pressure gauge.

4. A deterioration determination system, comprising:
the deterioration determination device according to claim 1; and
the rotating machine.

5. The deterioration determination system according to claim 4,
wherein the bearing box has:
an inner bearing box surrounding the bearing; and
an outer bearing box surrounding the inner bearing box,
wherein the second space is a space between the inner bearing box and the outer bearing box, and
wherein the sealing air supply pipe is configured to supply the sealing air into the second space.

6. The deterioration determination system according to claim 5,
wherein the rotating machine is a gas turbine,
wherein the high-temperature, high-pressure gas is compressed air discharged from an outlet of a compressor of the gas turbine, and
wherein the sealing air is compressed air extracted from an intermediate stage of the compressor upstream of the outlet.

7. The deterioration determination system according to claim 6,
wherein the sealing device is a brush seal.

8. A deterioration determination method for determining whether a sealing device of a rotating machine has deteriorated,
the rotating machine including:
a rotor;
a bearing rotatably supporting the rotor;
a bearing box surrounding the bearing;
a sealing air supply pipe that defines a sealing air supply passage for sealing air supplied to the bearing box to flow; and
a casing surrounding the bearing box, the casing separating the bearing box from an external space filled with high-temperature, high-pressure gas that has a higher temperature and higher pressure than the sealing air, the casing including an inner peripheral surface on which the sealing device is arranged between the inner peripheral surface and an outer peripheral surface of the rotor,
the deterioration determination method comprising a determination step of determining that the sealing device has deteriorated when a first pressure corresponding to pressure of a first space formed between the casing and the bearing box is greater than a second pressure corresponding to pressure of a second space formed inside the bearing box.
